(19) United States
(12) Patent Application Publication
(10) Pub. No.: US 2007/0071021 A1
(43) Pub. Date: Mar. 29, 2007

(54) Method for transmitting messages

(75) Inventor: Joao Girao, Heidelberg (DE)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/524,949

(22) Filed: Sep. 22, 2006

(30) Foreign Application Priority Data
Sep. 23, 2005 (DE) 10 2005 045 733.9

(51) Int. Cl. H04L 12/56

(52) U.S. Cl. 370/411

(57) ABSTRACT

A method for transmitting messages of at least one entity that creates messages to a target entity, wherein the messages sent by the creating entity are signed, wherein the individual entities are interconnected over a network, and wherein at least one aggregation entity, which combines several messages to an aggregated message, is provided in the network is—regarding a possibly simple and secure authentication—characterized in that by the aggregation entity a signature of the aggregated message is created in such a way that the aggregated message and the individual messages contained in the aggregated message can be verified at the target entity by knowing the aggregated message and the signature of the aggregated message.

### BACKGROUND OF THE INVENTION

1. Field of the Invention

The present invention relates to a method for transmitting messages of at least one entity that creates messages to a target entity wherein the messages sent by the creating entity are signed, wherein the individual entities are interconnected over a network and wherein there is at least one aggregation entity in the network provided which combines several messages as one aggregated message.

2. Description of the Related Art

With the increased capability of the currently available networks, the importance of the amount of transferred data has constantly decreased. Bigger amounts of data can usually be exchanged rather easily between two entities. Still, it can make sense for some applications—in particular in case of systems with wireless networks and mobile participants with limited power resources—to reduce the transmitted amount of data and to optimize it in order to increase the capability of the whole system.

The reasons are, for example, the limited capability of the receivers when processing the received data or the lack of necessity of extremely detailed information. The former is in particular the case with real time systems or systems with limited power resources. The latter can be of importance in many application cases. In this sense, it is for instance not necessary, when measuring a period of time during which a user has used a service, to transmit every single message about a still existing usage of the service. In contrast, it is sufficient to transmit and to store the whole period of usage and maybe the starting and/or finishing point in time of usage. In the same way, in the case of a sensor network which is supposed to determine an average measured value in a certain environment, the values of every individual sensor are not required.

Here, in a sensitive way, first the average value is determined using the initial individual measured values and only then are they transmitted to the corresponding target entity which triggered the event.

Such and other aggregation mechanisms have been known in engineering for a long time and are successfully applied. For this purpose, data that has been transmitted with several messages is collected at one or more aggregation entities and is combined with each other to form an aggregated message. For data aggregation, there are—as already indicated above—several methods available. In this sense, an addition or subtraction, the computation of an average value, the determination of a variance or further combining methods can be performed. Only after this aggregation the data is sent to a target entity in an aggregated message.

But when using aggregation, and in the context of several applications, specific security mechanisms are necessary, with which the transmitted messages can be protected against modifications and unauthorized creation by non-authorized creating entities.

These applications comprise, for example, electronic paying systems or an electronic performance of elections.

In order to meet these security requirements, aggregation systems as currently known follow several approaches, which in most cases make use of digital signatures. In case of one approach the individual signed messages are transmitted, unchanged, in one new message. After that, a signature is computed for the whole aggregated message and appended to the aggregated message. When receiving the aggregated message at the target entity, first of all the signature of the aggregation entity has to be checked in order to ensure the authentication of the aggregated message. Then, every message contained in the aggregated message has to be checked separately.

When reducing the amount of data, the signatures of the individual messages received have to be checked at the aggregation entity. After that, the data of the individual messages can be aggregated and embedded into a new message. This message has to be signed correspondingly and the signature has to be appended to the aggregated message. When receiving it at the target entity, it is sufficient to check the signature of the aggregated message. But in this case it must be ensured that the aggregation entity itself can be trusted unrestrictedly. This guarantee cannot always be given.

The problem with the approaches known in practice that in one of the cases always all the messages including the signatures are transmitted or at least the signature has to be checked at an intermediate station (here the aggregation entity). This creates an unnecessary huge amount of data that has to be transmitted, or an unnecessary huge amount of processing at the aggregation entity. In addition, the authentication becomes more complex. In the latter case, a check of the signatures at the aggregation entity has to be performed, due to which the aggregation entity has to be equipped with a lot of knowledge about the sending entities.

### SUMMARY OF THE INVENTION

Hence, the present invention is based on the task to design and further develop a method for transmitting messages of the above mentioned kind in such a way that a simple and secure authentication of the individual messages contained in an aggregated message is possible, as well as an authentication of the aggregated message itself.

According to the invention, the task mentioned above is solved by a method showing the characteristics of patent claim 1. According to this, the proposed method is characterized in that a signature of the aggregated message is created by the aggregation entity in such a way that the aggregated message and the individual messages contained in the aggregated message can be verified at the target entity by knowing the aggregated message and the signature of the aggregated message.

According to the invention, it has first been recognized that a secure authentication of the individual messages contained in an aggregated message, as well as that of the aggregated message itself is only possible if based on the knowledge of the aggregated message and its signature. For this purpose and according to the invention, the messages received at an aggregation entity are split into a data part and a signature part. These two parts are aggregated separately and preferably in parallel. In order to aggregate the signature, a signature function is applied which computes a signature in such a way that all the messages contained in the aggregated message can be verified together with its sender by only knowing the aggregated message and its signature.

The method according to the invention can be applied universally. It is neither restricted to a specific way of aggregating the messages nor to a specific application. The aggregation method should only be based on a mathematical operation.

In the same way, the method according to the invention can be used with very different network technologies and very different transport protocols. Just to give some examples, but in no way restricting the method to them, the application of the Ethernet, WLAN (Wireless Local Area Network) according to IEEEE 802.11 or UMTS should be mentioned. To give an example for the protocol, the IP protocol could be used.

In addition, the aggregation is not restricted to the aggregation of specific messages. In this sense, the messages of a single creating entity as well as the messages of several creating entities can be aggregated. Moreover, several messages collected over a period of time can be aggregated. It does not matter whether these messages were generated by a single entity or several entities.

In an especially advantageous way, for authentication of the individual messages contained in one aggregated message, the individual messages do not have to be available. In contrast, it is sufficient to know the aggregated message and its signature. If a correct signature is appended to the aggregated message, then not only the authentication of the aggregated message itself can be verified, but also that of the messages contained in the aggregated message.

This can be achieved by using a signature function when computing the signature of the aggregated message, which considers for the computation a signature based on the signatures of the messages that were received and combined in the aggregated message. Hence, if choosing the signature function in a smart way, it is possible to get some information about the signatures of the individual messages and not to lose it due to aggregation.

In addition, when computing the signature of the aggregated message, a key of the aggregation entity is used with which aggregation itself can also be authenticated.

Regarding an even higher level of security of the method, the signature function and the applied key of the aggregation entity can be designed in such a way that a correct signature of the aggregated message can only be created by a correspondingly authorized aggregation entity with a corresponding aggregation key. The key of the aggregation entity serves here as prerequisite for the correct aggregation of the signatures of the individual messages. In this case the key of the aggregation entity can be designed in such a way that the aggregation entity with this key is only able to create a correct signature in connection with the signatures that are received together with the messages to be aggregated. This means that the aggregation entity could not create validly signed messages by itself. Due to this fact, additional security can be created with the method according to the invention.

Depending on the application case of the method, it can make sense that every creating entity signs a sent message with the same key or that at least two keys different from each other are used by the creating entities. A uniform key could, for example, then be used if the messages that are to be aggregated, are only generated by one single creating entity or if an association of a message to a specific creating entity is not necessary. In this case, the message could only be associated to a group of creating entities. A signature which is based on different keys of the creating entities is in particular necessary with such systems where specific security guidelines have to be respected. For the electronic performance of an election, for instance, it has to be secured that a vote is only given by one specific person. In this case every elector would have to be provided with a distinct and unambiguous key for signing. In case of sensor networks, it is also very often necessary not only to know the measured values, but also to be able to exactly map the measured value to a specific sensor. In this case every sensor would have to be provided with a distinct key for signing, preferably an unambiguous key.

In addition, due to the usage of several keys, security is increased. If an unauthorized person manages to find a key of a creating entity, this person only has access to the messages that are signed with this key.

At the same time, application cases can be envisioned in which some entities or groups of entities use the same key to sign messages, whereas several keys are used in the whole system. In this sense, in case of the above mentioned sensor network, a group of sensors could determine an average value of a physical measure, whereas other sensors are supposed to measure a precise value. In this case, the group of sensors can be provided with a uniform key to sign the messages. Hence, depending on the application case various strategies can be used when distributing keys by arbitrarily choosing and/or combining the shown and further possibilities.

In a preferable way though, at least the aggregation entity shows a key that is different from the key(s) of the creating entity(ies). In this case, the key of the aggregation entity can be adjusted to the key(s) of the creating entity(ies). In this case, in particular, symmetric keys can be used. Moreover, the application of all mutual adjustments of keys as known in practice can be envisioned.

Moreover, the very different methods for key storage known in practice are applicable. In this sense, keys can be stored in the form of software as a variable in the system or can be stored on a separate chip. It can be provided that the keys are changeable or that the keys are protected only by exchange of a module or other security mechanisms.

If demanded by the application, the messages to be aggregated received at an aggregation entity could be checked regarding their authentication. This check takes preferably place before aggregation and only those messages could be aggregated that could be correctly authenticated. In order to verify the messages, the signature of the message is checked with respect to the fact whether the message and the signature can fit. To do so, the methods known in practice that are used in the context with the signing method, are applied.

In case an authentication of an aggregated message performed by the target entity fails, it can be provided that the target entity requests the aggregation entity to transmit the individual messages contained in the aggregated message. To do so, it is necessary that the aggregation entity buffers for a certain time the corresponding messages which it aggregates. This period can be chosen to be longer or shorter, depending on the application. The individual messages contained in the aggregated message are then separately checked by the target entity regarding their authentication. For this purpose the target entity has to be provided with the keys that may under certain circumstances be necessary to check the signatures, the former can be stored at the target entity itself or at another location within the network.

Regarding a further, particularly universal application of the method the aggregation entities can be cascaded. In this sense it is not exclusively necessary that the messages of a creating entity are supplied to an aggregation entity. In contrary, already aggregated messages of one or more aggregation entities could be combined by an aggregation entity. In this case the received aggregated messages are processed as described above. This becomes possible due to the special design of the aggregation of the signatures. In particular, mixed forms are also possible, i.e. the aggregation of individual messages—generated by creating entities—and already aggregated messages.

An aggregation of aggregated messages can, for example, be necessary when performing elections electronically. The messages of an individual polling station can be aggregated over several terminals and/or over a specific time. The aggregated messages of several polling stations could be connected as an aggregated message over all the polling stations of a town. Further aggregations could be applied to the level of electoral districts and counties.

Now, there are several options of how to design and to further develop the teaching of the present invention in an advantageous way. For this purpose, it must be referred to the claims subordinate to claim 1 on the one hand and to the following explanation of preferred examples of an embodiment of the invention together with the figure on the other hand. In connection with the explanation of the preferred example of an embodiment of the invention and the figure, generally preferred designs and further developments of the teaching will also be explained.

### BRIEF DESCRIPTION OF THE DRAWINGS

FIG. 1 is a diagram showing the structure of a system for the application of a method according to an embodiment of the invention;

FIG. 2 is a diagram showing the signal flow during the processing the signatures when applying the method according to an embodiment of the invention; and

FIG. 3 is a diagram showing an example of the sequence over time of sending messages of one individual creating entity.

### DESCRIPTION OF THE PREFERRED EMBODIMENTS

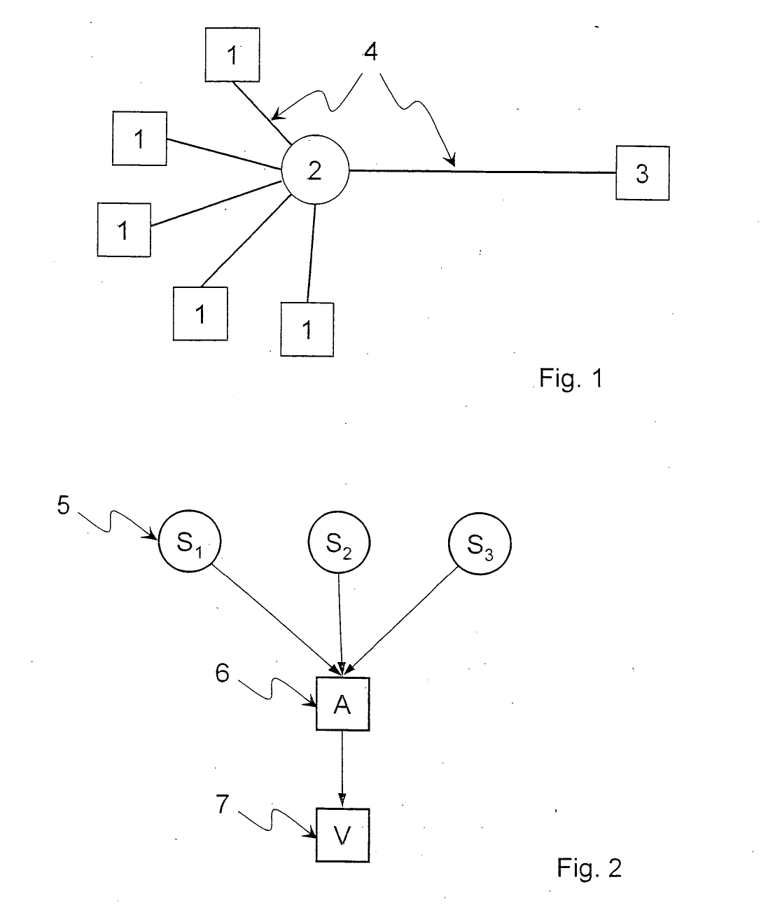

FIG. 1 shows in a scheme an example of an embodiment for the application of the method according to the invention. Several creating entities 1 generate messages that are sent to an aggregation entity 2. The aggregation entity transmits the aggregated message to a target entity 3. The individual entities are interconnected over network connections 4. Over this network the messages, possibly necessary signals, requests and further information and data are sent. The network connections can differ in design. In this sense the creating entities could comprise sensor systems that are connected to the aggregation entity over a WLAN connection. For the connection of the aggregation entity with the target entity, a DSL connection could be used.

In FIG. 2 the signal flows of a simple example of an embodiment are depicted. Individual messages generated by one or more creating entities are aggregated (aggregation 6) in the aggregation entity 2.

FIG. 2 shows the processing of the signatures of the individual messages. The signatures S₁, S₂ and S₃ are merged by an aggregation 6. In addition, the key of the aggregation entity 2 is used for computing the aggregated signature from the signatures S₁, S₂ and S₃. Finally, the aggregated signature that is transmitted with the aggregated message to the target entity is verified at the target entity 3 in a verification step 7. Here, it should explicitly be pointed out that it does not matter whether the signatures 5 are created by one or more creating entities 1 and/or by an aggregation entity 2.

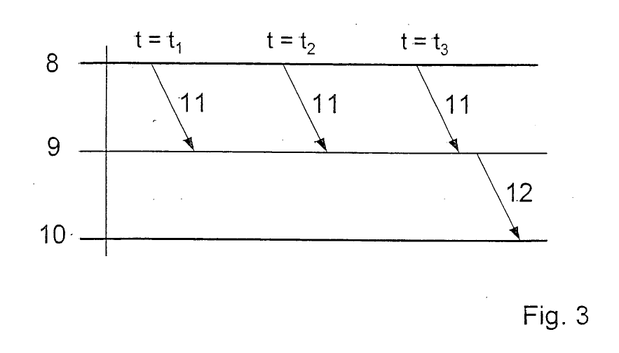

FIG. 3 shows the application of the method according to the invention when aggregating messages which are—in this example of an embodiment—generated only by one creating entity 1. With this Fig. the application of the method according to the invention should be illustrated in case of an AAA (Authentication, Authorisation, Accounting) server. AAA servers are used in wireless networks to control the system access and account for usage time. In the example depicted in FIG. 3, a mobile station 8 creates messages at times T₁, T₂ and T₃ to the access router 9 and requests with these messages the authorization for using the wireless network for a certain period. In this case every message 5 is signed correspondingly by the mobile station 8.

In order to sign the messages, a specific signature method which is based on ECC (Elliptic Curve Cryptography) is used. In case of ECC, a so-called DLP (Discrete Logarithm Problem) exists, and according to this, the discrete logarithm is hard to compute. Hence, the inverse function of the elliptic curve scalar multiplication (of a number in the set Z with a point) cannot be computed any more with reasonable efforts. In the case of certain curves, the computation effort becomes so tremendously high that it is almost impossible to compute the inverse function. On the curve a specific point G exists which can be used to generate other points on the curve by arbitrarily iterative additions with itself. This point is called a generator.

By this signature generation function a signature C is computed for the message m. To do so, the key (α, β, Θ) of the creating entity is necessary. Before the actual computation takes place, the message m is mapped on the curve. The hence resulting point is called M. In order to increase security, a random point R is added to the signature function, which itself is computed by the product of a random number k with the generator K. A signature can consequently be generated by:
C=α*M+β*R+Θ*G (1)
The asterisk indicates a multiplication of a number in the set Z with a point creating another point in the curve. If in addition, specific (α,β, Θ) are chosen, the computation can be further simplified. In the example shown here, α=s³, β=s² and Θ=s, wherein s is a fixed integer.

Since not every message has to be known at the AAA server for requesting a certain usage time, the access router 9 acts aggregation unit 2. Therefore, the access router 9 collects at different intervals messages 5 received from the mobile station 8 and aggregates the messages having occurred until that point in time after a defined number of messages, after a defined period or after a corresponding message of the mobile station 8 about the end of usage.

For this purpose the data part and the signature part of the messages 5 of the mobile station 8 are separated and aggregated in parallel. An aggregation of the data is in this case represented by an addition of the individual periods of time.

When aggregating the signatures C₁ and C₂ of the individual messages 11, a signature function computes a signature C₃ of the aggregated message 12 from the individual messages 5 received by the access router 9. In this case, the signatures of the individual messages 11, as well as the messages 11 themselves are added. Since for all the signatures of the messages 11 the same key was used, the aggregation of the signatures in particularly simple. Due to the kind of the signature, the signature of the aggregated message 12 can be computed with:
C₃=C₁+C₂−sG (2)
In this case sG is the key of the aggregation entity with the meanings of s and G as defined above. Only if this key is known, a correct signature can be computed. By inserting of equation (1) for both messages M₁ and M₂ in equation (2), it can easily be proved that the signature C₃ is a correct signature for the message M₃=M₁+M₂. For the aggregation of more than two messages, the connection as shown in formula (2) has to be applied several times. The result is that an (i−1) times subtraction of the key sG of the aggregation entity is necessary, wherein i is the number of messages to be aggregated 11.

When using different keys, the formula and the generation of the keys of the aggregation entity become more complex, the method itself remains unaltered as matter of principle. Due to this fact, further explanations are skipped here.

It can clearly be seen that here the key of the aggregation entity is chosen in such a way that a correct signature of the aggregated message can be computed by the aggregation entity. Considering the key itself, though, is in general not able to compute a signature of its own. The signatures of messages to be aggregated are always necessary. Due to this, it is ensured that the aggregation entity only forwards the aggregated messages and does not create messages of its own. Due to this fact, a not unrestrictedly trustworthy aggregation entity can perform an aggregation.

The aggregated data and the computed signature of the aggregated message are finally combined into an aggregated message 12 and transmitted to the AAA server 10. There a verification of the aggregated message 12 is performed. If the aggregated message contains a correct signature, it can be secured that—due to the specific kind of verifying the signature—it can be assumed that the messages contained in the aggregated message have been authenticated.

Finally, it is particularly important to point out that the completely arbitrarily chosen examples of an embodiment from above only serve as illustration of the teaching as according to the invention, but that they do by no means restrict the latter to the given examples of an embodiment.

1. A method for transmitting messages of at least one entity that creates messages to a target entity, wherein the messages sent by the creating entity are signed, wherein the individual entities are interconnected over a network, and wherein at least one aggregation entity, which combines several messages to an aggregated message, is provided in the network, wherein by the aggregation entity a signature of the aggregated message is created in such a way that the aggregated message and the individual messages contained in the aggregated message can be verified at the target entity by knowing the aggregated message and the signature of the aggregated message.

2. The method according to claim 1, wherein the target entity has no information about the individual messages that are contained in the aggregated message.

3. The method according to claim 1, wherein the signature of the aggregated message is computed by a signature function, wherein the signatures of the received messages and a key of the aggregation entity are used by the signature function to compute the signature of the aggregated message.

4. The method according to claim 1, wherein the signature function is designed in such a way that the creation of a correct signature of an aggregated message is only made possible for authorized aggregation entities with a correspondingly appropriate key.

5. The method according to claim 1, wherein the messages sent by the creating entities are signed by every creating entity with the same key.

6. The method according to claim 1, wherein at least two keys different from each other are used for signing messages by the creating entities.

7. The method according to claim 1, wherein a key differing from the creating entities is used by the aggregation entity when creating a signature of the aggregated message.

8. The method according to claim 7, wherein the key of the aggregation entity is adjusted to the keys of the creating entities sending messages to the aggregation entity.

9. The method according to claim 1, wherein the messages received by an aggregation entity for aggregation are checked regarding their authentication, wherein the signature of the messages is checked for checking the authentication.

10. The method according to claim 1, wherein in case of a failed authentication of an aggregated message, the individual messages contained in the aggregated message and/or the keys necessary for checking are requested by the target entity and every single message is checked separately regarding its authentication.

11. The method according to claim 1, wherein the aggregated messages of one or more aggregation entities are connected by an additional aggregation entity.

12. The method according to claim 11, wherein the messages received by the additional aggregation entity are processed in the same way as the messages of one or more creating entities.
